(19) United States
(12) Patent Application Publication
(10) Pub. No.: US 2007/0038849 A1
(43) Pub. Date: Feb. 15, 2007

(54) Computing system and method

(76) Inventor: Rajiv Madampath, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,676

(22) Filed: Jul. 24, 2006

(30) Foreign Application Priority Data
Aug. 11, 2005 (IN) IN1120/CHE/2005

(51) Int. Cl. G06F 9/44

(52) U.S. Cl. 712/228

(57) ABSTRACT

A computing system comprising: a first processor set for executing a first instance of software; a second processor set; and a delay unit that causes said second processor set to execute a second instance of said software at a predetermined delay to said first processor set, whereby a software error recovery can be attempted on the basis of the second instance of said software if said first instance of said software fails.

### BACKGROUND OF INVENTION

Existing techniques for software fault-tolerance and recovery include checkpointing, recovery blocks and process pairs. Checkpointing typically requires storage of large data sets which represents the application's state at the time of checkpointing, so that if a software fault occurs, it is possible to rewind the process back to the last checkpoint and then continue execution from the checkpoint. This technique has performance overheads in terms of both time and space since the time required to check point can be significant and the amount of data that has to be written to memory to form the checkpoint can be large. Therefore, checkpointing may not be justifiable because of the potential performance loss. Further, the run time environment has to be modified in order to support application restart at a given checkpoint state.

Recovery blocks are an example of N-version programming which rely on N wholly independent versions of the software block being available for use as standbys if the primary block fails. Process pairs rely on transferring state information from a primary process to a back up process which can execute if the primary fails. The latter approach assumes that most of the errors are transient in nature (also called Heisen bugs) and thus the back up process, which may execute on a different processor, on another machine, may not encounter the same error. Hardware fault-tolerance has historically relied on redundancy of hardware elements and an example is the Hewlett-Packard Tandem system. Hewlett-Packard Tandem systems cater to hardware and software fault-tolerance. Hardware fault-tolerance is accomplished by incorporating redundancy at the hardware level. Software fault-tolerance is accomplished through the use of processed pairs. Redundant hardware paths and redundant hardware modules provide for transparent failover in the case of failure of any path or module. The software fault-tolerance of such systems caters to a very narrow spectrum of software failures which are due to transient errors in hardware. The process pairs synchronise at checkpoints with the master copy sending the set of changes since the last checkpoint to the secondary. In the event of a failure on the master program, the other unit continues to operate and provide output for hardware failures and revert to the last checkpoint for software failures.

In the case of software design faults, the secondary program cannot bypass the error since the architecture of a Hewlett-Packard Tandem system accounts only for software errors that are due to transient hardware errors.

### BRIEF DESCRIPTION OF THE DRAWINGS

The present invention will now be described, by way of example only, with reference to the accompanying drawings, in which:

FIG. 1 is a schematic diagram showing a two processor system of a first preferred embodiment;

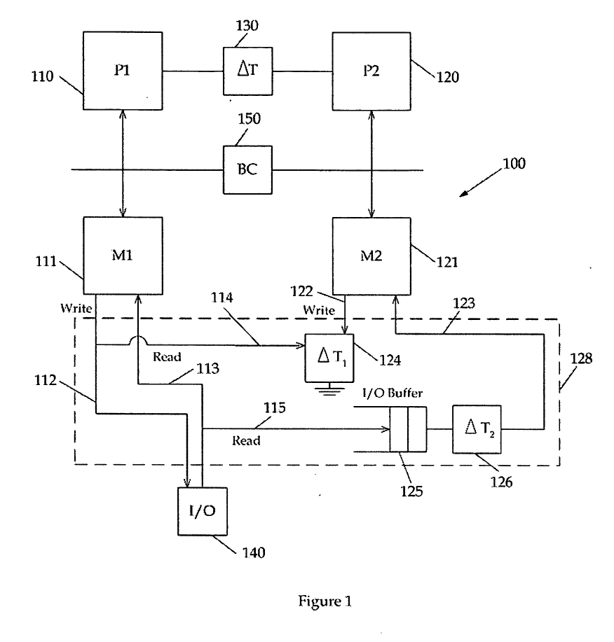

FIG. 2 is a flowchart showing how the method of the first embodiment can be carried out;

FIG. 3 is a schematic diagram of a computing system of a second embodiment showing how the computing system can be generalised to more than one redundant processor; and

FIG. 4 is a flow chart corresponding to the method of the second embodiment.

### DETAILED DESCRIPTION OF INVENTION

There will be described a computing system comprising:

a first processor set for executing a first instance of software;

a second processor set; and

a delay unit that causes said second processor to execute a second instance of said software at a predetermined delay to said first processor set, whereby a software error recovery can be attempted on the basis of the second instance of said software if said first instance of said software fails.

In one embodiment the computing system comprises a redundancy support unit that enables said second processor set to carry out write and read operations while said first instance of software is executing correctly.

In one embodiment said redundancy support unit comprises a buffer and a read delay unit for providing I/O reads produced in response to execution of said primary instance of software by said first processor set to said second processor set at said predetermined delay.

In one embodiment said redundancy support unit comprises a write delay unit for implementing I/O writes from the second processor as delays and obtaining the delay period and the write operation's return status from the corresponding write operation initiated on the first processor.

In one embodiment the computing system comprises I processor sets, where I is an integer of three or more such that there is at least one processor set in addition to the first and second processor set, the delay unit being configured such that processor i executes an instance i of said software at a predetermined delay from processor i-1, whereby if all software instances up to and including software instance i-1 executing on processor set i-1 fail, software error recovery can be attempted on the basis of the instance i of said software

The technique disclosed also provides a computing method comprising:

executing a first instance of software; and

executing a second instance of software at a predetermined delay to said first instance, whereby software error recovery can be attempted on the basis of the second instance of software if the first instance fails.

In an alternative aspect, the technique may be described as a computing system comprising:

I processor sets, where I is a positive integer of two or more, one of said I processor sets acting as a primary processor set and processing a primary instance of software; and

a redundancy unit for configuring each of the other I-1 processors to act as a cascading series of I-1 redundant processor sets, a first redundant processor set of said series configured by said redundancy unit to execute a second instance of said software at a predetermined time delay to said first processor set, any subsequent redundant processor sets each executing a further instance of said software at a time delay greater than that of the preceding redundant processor set in the series, whereby if said instance of said software fails software recovery can be attempted on the basis of one of said redundant processor sets whose instance of said software has not failed.

In an embodiment of this alternative aspect said redundancy support unit comprises a buffer and a read delay unit for providing I/O reads produced in response to execution of said primary instance of software by said primary processor set to each redundant set at a delay corresponding respectively to the delay of the redundant processor set from the primary processor set.

In an embodiment of this alternative aspect said redundancy support unit comprises a write delay unit for implementing I/O writes from each redundant processor set as delays and obtaining the delay period and the write operation's return status from the corresponding write operation initiated on the primary processor set.

In an embodiment of this alternative aspect, the computing system comprises a fault recovery unit for attempting software error recovery on the basis of a highest order instance of said software which has not failed if said primary instance of said software fails.

In an embodiment of this alternative aspect said fault recovery unit comprises a switching unit for switching to primary processing by the redundant processor set executing the highest order instance of the software that has not failed, such that the highest order instance of software becomes the primary instance. Each processor set may comprise a single processor and/or two processors.

In this alternative aspect, the technique may also be described as a computing method comprising:

executing I instances of software, where I is a positive integer of two or more one of said instances being a primary instance, each of the other I-N instances being a cascading series of redundant instances to said primary each being executed at a time delay to the preceding instance, such that each instance is executed at a cumulative time delay to the primary instance, whereby if said primary instance of said software fails, software recovery can be attempted on the basis of one of said other I-1 instances that has not failed.

In an embodiment of this alternative aspect the computing method comprises attempting software recovery on the basis of the highest order of said other I-1 instances that has not failed.

In a first embodiment, the computing system comprises a first processor 110 having first main memory 111 and a second processor 120 having a second main memory 121. The computing system 100 has a delay mechanism in the form of delay unit 130 that ensures that each instruction is executed on the second processor 120 exactly ΔT cycles after its execution on the first processor 110. Thus, the delay unit ensures that the second processor lags the first processor by a predetermined period in clock cycles. As will be described in further detail below, the first embodiment can be extended to cases where the first processor 110 and second processor 120 are replaced by processor sets each having a processor pair. (Alternatively, the example of single processors can be thought of as a special case where the number of processors in each set is one.)

By executing a second instance of the same software at a predetermined delay from the first instance using the second processor 120, software error recovery can be attempted on the basis of the second instance of the software if the first instance of the software fails.

In order to enable the second processor to carry out write and read operations while the primary instance software is executing correctly on the first processor 110, the computing system 100 incorporates a redundancy support unit 128. The redundancy support unit 128 has a plurality of components. In order to support write operations, writes from the second main memory 121 and the second processor 120 are implemented as delays. The delay that is implemented ΔT₁ is the delay that an I/O write operation takes on the first processor 110. This delay, ΔT₁, is determined and provided to the write delay unit 124 when an I/O write operation happens on M1 as indicated by line 114. This ensures that the write operation as indicated by line 122 from the second main memory 121 of the second processor 120 takes the same time as the write on the first processor 110. The write operation's return status is also provided to the second processor 120 from the corresponding write operation initiated by the first processor 110.

All input/output reads are processed in the normal way for the first processor 110 and the first processor main memory 111. In the case of the second processor 120, the read from the I/O unit 114 which is passed to the first main memory 111 of the first processor 110 as indicated by line 113 is also copied as indicated by line 115 to an input/output buffer 125. Delay ΔT₂ is applied by read delay unit 126 in order to ensure that the reads are reflected in the second main memory 121 after a delay of ΔT from the corresponding update of the first main memory 111.

In the preferred embodiment data reads from I/O devices 140 are transferred to main memory 111,121 in blocks and that all I/O read operations are serialised to main memory through a single bus. For example, in DMA transfers over a single PCI bus. Take the example of block A and denote by t1 the start time of block transfer for this block and by t2 the end time of this block transfer. Both t1 and t2 are provided to the I/O delay buffer 125. Block A begins to get transferred by the delay buffer to second main memory 121 at t3=t1+ΔT and the transfer ends at t4=t2+ΔT. Thus, the transfer of the last block for a particular read operation results in the return from the recall from the second processor 120 and the second main memory 121 with the same return status as on the first processor 110 and first main memory 111 but at the requisite delay of ΔT.

As indicated above, the method can be implemented for processor pairs. For example, a first processor may have access to a second main memory attached to a third processor on another cell thus forming a first processor set 110 and a fourth processor having a fourth main memory may be the redundant processor for a third processor 120 thus forming a second processor set. In this configuration the first processor will be able to access the first main memory as well as the second main memory. Similarly, the third processor will be able to access the third main memory and fourth main memory. Process migration is handled by a process migrating from the first set to the second set. That is, from the first processor and second processor acting as a first set 110 to the third processor and fourth processor acting as a second set 120.

Thus a migrating process will be queued on the third processor's schedule's queue and will also be scheduled onto the fourth processor's queue after the delay since this will be routed through a delay unit of the second processor pair 120. Therefore, the delay unit will in effect service the process migration request coming through the external bus.

Accordingly, it will be appreciated that the above and following description applies equally to processor set configuration as to single processor configurations. The bus controller 150 electrically isolates the processors except under conditions as will be discussed in further detail below.

In the first embodiment, the system 100 is configured so that if a software fault happens on the first processor 110, the system 100 immediately switches to the lagging processor 120 by employing a cross-process interrupt. The system 100 sends an error message to the relevant display. When the error occurs, the second processor 120 has the state of the system at ΔT clock cycles before the crash. A variety of actions can now be initiated depending on the type of error recovery desired. That is, error recovery can be attempted on the basis on the second instance of the software running on the second processor 120.

A first example is a case where the fault is an operating system failure such as a panic or crash. The second processor 120 can be used to form single-user debugging of the contents of the first processor 110 and the first processor main memory 111. Depending on the result of debugging, various actions can be taken. For example, with first main memory 111 and the registers in the first processor 110 with correct/consistent values and resuming with the first processor 110 as the lead processor. This can be achieved by switching the bus controller to the on state and enabling the second processor 120 to write to the first processor 110 and its main memory 111.

A second example is an application faults in which a possible action could be flushing the I/O buffer entries corresponding to the crashing application. The flush operation will cause the I/O read system calls that are waiting for I/O completion for the second processor 120 to return with an error. The application that initiated the read operation will deal with the failed read operations thereby executing a failure path and possibly avoiding the path of the bugs. Thus, the system 100 could potentially continue processing normally with the second processor 120 as the lead processor with a lower probability of the crash re-occurring.

The system 100 is configured such that the relevant connections of the redundancy support unit 128 are reversed after the I/O delay buffer 125 is emptied so that in the second instance of the software executing on the second processor becomes the primary instance and the first processor 110 begins executing a secondary instance behind the second processor by a delay of ΔT.

In a third example, for operating system failures, a similar I/O delay buffer flush could result in the lagging processor 120 executing the error paths therefore avoiding the possibility of the imminent panic or crash. An operating system executing its error paths could cascade onto applications running on the systems some of which would probably execute their own error handling control paths as well. For example, if the bug is in the virtual memory subsystem of the kernel such as in the page-fault path (the kernel code executed during swapping pages in or out of main memory), applications owning such pages could potentially be terminated rather than the operating system itself going down. This is generally more acceptable than application failure.

Typically, not all application failures will be used to trigger the failover mechanism. That is, certain application failures should be specially marked. This can be achieved by passing a flag to the tool that modifies the executable header and hence causes the runtime environment to behave in this manner.

Once the switch over to the lagging processor occurs 120, the delay buffer is allowed to be drained out by the second processor 120 before the redundancy support unit 128 and delay unit 130 connections are reversed. Thus, since the I/O writes from the second processor 120 are still implemented as delays until the buffer 125 drains out, the replay of events is not visible to the external world. Once the delay buffer 125 is drained of its contents and the connections are interchanged, the second processor 120 becomes the primary processor and there is no visible effect to the external world other than a brief delay during the draining-out process and subsequent synchronising of the first main memory 111 with the second main memory 121. To reduce the performance penalty during the memory synchronisation, the computing system 100 maintains a list of pages written to by the first main memory 111 during the last ΔT time period. Only these pages are transferred from the second main memory 121 to the first main memory 111 to reinitialise their contents. To the external world, the only difference in behaviour observed is for the crashed application which will execute its error handling paths during the ΔT time period where the delay buffer 125 is being drained out, pending I/O transfers are cancelled since these I/O reads initiated by the first processor 110 which will be reinitiated by the second processor 120 once the connections are interchanged.

The actual value of ΔT will be chosen based on a number of factors. For example, on the basis of gestation periods of software faults. A gestation period is the time between the occurrence of a fault trigger and the time between it takes the fault to manifest. Typically, the worst case scenario of a continuous I/O burst between a ΔT will determine the size of the delay to be used. Multiple levels of rollback can be supported by adding additional redundant processors as we describe in more detail below. These redundant processors are designed to run further behind the second processor 120 so that if recovery by the second processor fails because the error manifested itself in a time longer than supported by the redundancy support unit 128, the system 100 can switch successively to a processor/processor set on which the software fault has not occurred. The use of multiple levels of redundant processors also ameliorates against the situation of compute-intensive applications which perform very limited input/output as well as the case where the software fault does not involve data read from an input/output operation (such as a segmentation fault). That is, the fault may already have occurred on the second processor and the manifestation of the fault may still be latent and hence emptying the I/O delay buffer 125 may or may not lead to the eventual crash.

The above system augments the fault tolerant capabilities of existing fault-tolerant architectures.

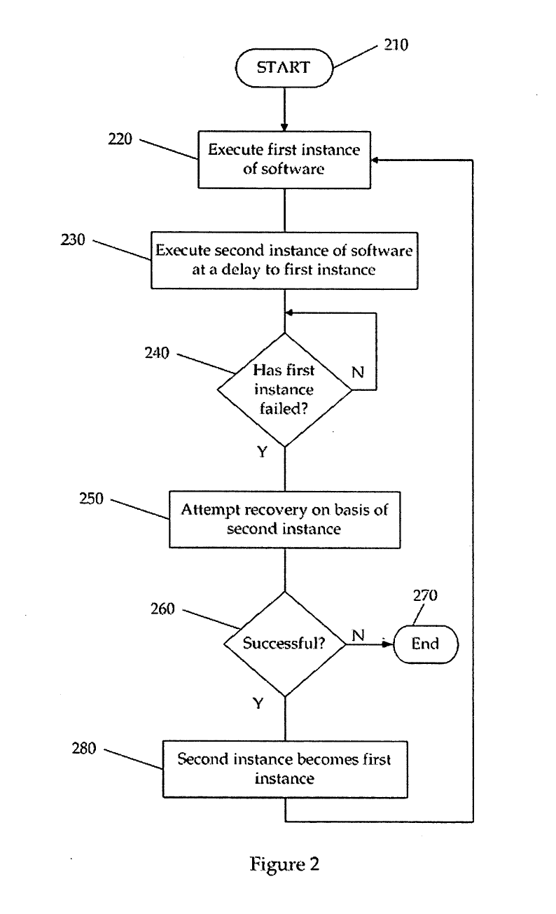

The process employed in the above method is illustrated in the flowchart of FIG. 2. When the process starts at step 210, a first instance of software is executed at step 220 and a second instance of software is executed at step 230 at a delay to the first instance.

The system continually monitors at step 240 whether the first instance has failed. While the first instance of software has not failed, the system 100 continually loops through the checking process of step 240. If the first instance fails at step 240, at step 250 the fault software-fault recovery is attempted on the basis of the second instance of the software.

If this is unsuccessful at step 260, the process ends at step 270. If it is successful at step 260, the connections are switched and the second instance becomes the first instance of the software at step 280 and the process loops through step 220.

A second embodiment will now be described which shows how the computing system can be extended to incorporate two or more redundant processors.

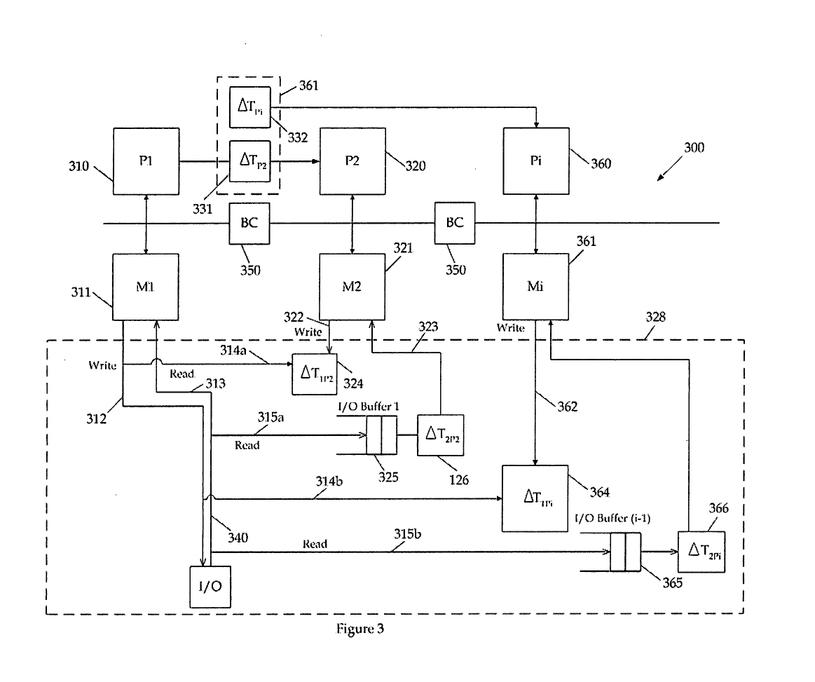

Referring to FIG. 3, the first processor 310 executes a first instance of software. The first processor has a first main memory 311 and writes as indicated by line 312 to the input/output devices 340 and reads 313 from the input/outputs device 340.

The time delay unit 330 implements a plurality of different time delays. A time delay ΔTₚ₂ 331 for the second processor 320 and a time delay ΔT_{Pi} 332 for the ith processor, Pi 360.

The delay ΔT_{Pi} 332 is greater than the delay ΔTₚ₂. That is, for each successive additional processor, the delay in greater than the preceding processor. The second processor has a second memory 321 and the ith processor has ith memory 361. Each of the additional redundant processors 321,361 shares the redundancy support unit 328. That is, redundancy support unit 328 has a write delay unit 324, an I/O buffer 325 and a read delay unit 326 are provided for the second processor. The second processor writes 322 to the write delay unit 324 which obtains write information 314a from the primary processor 320. Similarly, reads 315a are supplied to the input/output buffer 325 and returned to the second main memory 321 at an appropriate delay as indicated by line 323. The redundancy support unit 328 also provides the ith processor 360 with a write delay unit 364 to which the ith main memory 361 writes and which receives write delay information and write status as indicated by line 314b. The ith processor 360 also has a input/output buffer 365 and a read delay unit 366 so that reads 363 are provided to the memory 361 at a delay corresponding to ΔT. The reads are provided as indicated by line 315b.

Thus, in the embodiment illustrated in FIG. 3, error recovery can be attempted successively on each redundant processor 320,360 until one is located where the error has not manifested.

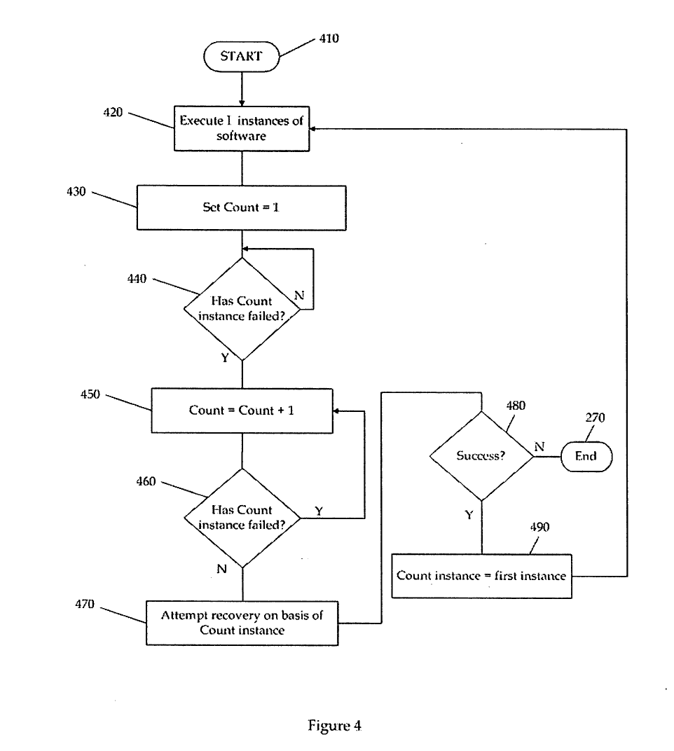

This process is illustrated in FIG. 4. The process starts at step 410. At step 420 I instances of the software are executed on respective ones of a set of I processors, so that there is a series of redundant processors running a series of cascading instances of software each successively delayed from one another so that the further into the series one progresses, the greater the delay.

As indicated in FIG. 4, a counter is used to maintain track of which processor has yet to fail. At step 430, this counter is set to 1. At step 440 it is determined whether the current instances has failed. Hence, initially whether the first instance of the software has failed. If it has not, the process continues to loop through step 440 until there is failure. If there is a failure, at step 450 the counter is increased by one and at step 460 the system 30 determines whether this instance has failed. If it has failed, the counter is increased again and the process loops until an instance is found where the software has not failed. At step 470 recovery is attempted on the basis of the relevant software instance. At step 480 if there is no success the process ends at step 485. If there is success, the current instance of the software is set to be the first instance and the delay 330 and redundancy support units 328 are reconfigured and the process loops to step 420.

Various modifications will be apparent to persons skilled in the art and should be considered as falling within the scope of the technique disclosed here.

1. A computing system comprising:
a first processor set for executing a first instance of software;
a second processor set; and
a delay unit that causes said second processor set to execute a second instance of said software at a predetermined delay to said first processor set, whereby a software error recovery can be attempted on the basis of the second instance of said software if said first instance of said software fails.

2. A computing system as claimed in claim 1, comprising a redundancy support unit that enables said second processor set to carry out write and read operations while said first instance of software is executing correctly.

3. A computing system as claimed in claim 2, wherein said redundancy support unit comprises a buffer and a read delay unit for providing I/O reads produced in response to execution of said primary instance of software by said first processor set to said second processor set at said predetermined delay.

4. A computing system as claimed in claim 2, wherein said redundancy support unit comprises a write delay unit for implementing I/O writes from the second processor as delays and obtaining the delay period and the write operation's return status from the corresponding write operation initiated on the first processor.

5. A computing system as claimed in claim 1, further comprising a fault recovery unit for attempting software error recovery on the basis of the second instance of said software if said first instance of said software fails.

6. A computing system as claimed in claim 5, wherein said fault recovery unit comprises a switching unit for switching to primary processing by said second processor set, such that said second instance of said software becomes the primary instance.

7. A computing system as claimed in claim 6, wherein said fault recovery unit reverses I/O connections so that the first processor set executes a secondary instance of said software and said redundancy support mechanism enables said first processor set to carry out write and read operations while said primary instance of software is executing correctly.

8. A computing system as claimed claim 1, comprising I processor sets, where I is an integer of three or more such that there is at least one processor set in addition to the first and second processor set, the delay unit being configured such that processor i executes an instance i of said software at a predetermined delay from processor i-1, whereby if all software instances up to and including software instance i-1 executing on processor set i-1 fail, software error recovery can be attempted on the basis of the instance i of said software

9. A computing system as claimed in claim 1, wherein each processor set comprises a single processor.

10. A computing system as claimed in claim 1, wherein each processor set comprises two processors.

11. A computing method comprising:
executing a first instance of software; and
executing a second instance of software at a predetermined delay to said first instance, whereby software error recovery can be attempted on the basis of the second instance of software if the first instance fails.

12. A computing method as claimed in claim 11, further comprising attempting software error recovery on the basis of the secondary instance of said software.

13. A computing system comprising:
I processor sets, where I is a positive integer of two or more, one of said I processor sets acting as a primary processor set and processing a primary instance of software; and
a redundancy unit for configuring each of the other I-1 processors to act as a cascading series of I-1 redundant processor sets, a first redundant processor set of said series configured by said redundancy unit to execute a second instance of said software at a predetermined time delay to said first processor set, any subsequent redundant processor sets each executing a further instance of said software at a time delay greater than that of the preceding redundant processor set in the series, whereby if said instance of said software fails software recovery can be attempted on the basis of one of said redundant processor sets whose instance of said software has not failed.

14. A computing system as claimed in claim 13, comprising a redundancy support unit that enables each redundant processor set to carry out write and read operations while said instances of software executed by preceding processor set is executing correctly.

15. A computing system as claimed in claim 14, wherein said redundancy support unit comprises a buffer and a read delay unit for providing I/O reads produced in response to execution of said primary instance of software by said primary processor set to each redundant set at a delay corresponding respectively to the delay of the redundant processor set from the primary processor set.

16. A computing system as claimed in claim 14, wherein said redundancy support unit comprises a write delay unit for implementing I/O writes from each redundant processor set as delays and obtaining the delay period and the write operation's return status from the corresponding write operation initiated on the primary processor set.

17. A computing system as claimed in claim 13, further comprising a fault recovery unit for attempting software error recovery on the basis of a highest order instance of said software which has not failed if said primary instance of said software fails.

18. A computing system as claimed in claim 17, wherein said fault recovery unit comprises a switching unit for switching to primary processing by the redundant processor set executing the highest order instance of the software that has not failed, such that the highest order instance of software becomes the primary instance.

19. A computing system as claimed in claim 18, wherein said fault recovery unit reconfigures I/O connections and said redundancy support mechanism so that processors that were running failed instances of said software act as redundant processor sets.

20. A computing system as claimed in claim 13, wherein each processor set comprises two processors.
